(19) United States
(12) Patent Application Publication
(10) Pub. No.: US 2015/0112846 A1
(43) Pub. Date: Apr. 23, 2015

(54) Futures Contracts Settlement Method with Option to Roll Forward

(71) Applicant: Chicago Mercantile Exchange, Inc., Chicago, IL (US)

(72) Inventors: John Labuszewski, Westmont, IL (US); John Nyhoff, Darien, IL (US); John Kerpel, Chicago, IL (US); Greg Skony, Park Ridge, IL (US); Richard Co, Chicago, IL (US)

(73) Assignee: Chicago Mercantile Exchange, Inc., Chicago, IL (US)

(21) Appl. No.: 14/056,660

(22) Filed: Oct. 17, 2013

(51) Int. Cl. G06Q 40/04

(52) U.S. Cl. CPC G06Q 40/04
USPC 705/37

(57) ABSTRACT

Systems and methods are provided for processing derivative financial instrument positions. Contracts are structured to include minimum position limits or thresholds as final settlement dates approach. The minimum position limits or thresholds exceed the trading units. Traders who initially hold relatively small positions are required to increase their positions as the settlement date approaches so that the position at settlement corresponds to quantities used in commercial institutional markets. Limits or thresholds are enforced by imposing a fee for non-compliance, forcing cash settlement or requiring a mandatory roll forward of at least some of the positions. The roll forward may include a spread product that includes a first derivative financial instrument having a first settlement date and a second derivative financial instrument having a second settlement date that is different from the first settlement date. The price of the spread product is based on daily settlement values associated with the first and second derivative financial instruments.

### FIELD OF THE INVENTION

The present invention relates to the processing of financial product orders, in particular, to methods and systems for processing futures contracts as settlement dates approach.

### DESCRIPTION OF THE RELATED ART

Futures contracts generally obligate buyers and sellers to purchase and sell an asset at a predetermined time and at a predetermined price. Assets may include physical commodities and financial instruments. Futures contracts can specify settlement by physical delivery or by cash. Settling a futures contract with physical delivery involves delivering the asset. For example, a quantity of corn may be delivered to a specific location or a currency payment may be made to settle the futures contract. Alternatively, some futures contracts specify that they will be cash settled. Cash settlement may include a cash payment that is the difference between a spot price and the price specified by the futures contract.

Cash settlement is convenient for parties not wishing to take or transfer actual possession of underlying assets. For example, a party may wish to hedge risks associated with the price of oil by purchasing an oil futures contract and the party may have no desire or ability to take possession of oil at the end of the contract. Physical delivery may be preferred by some traders and for some futures contracts. For example, some traders prefer physical delivery of currencies associated with currency futures contracts.

Physical delivery is not always the optimal option for settlement of futures contracts. One common issue relates to contract size. Futures exchanges and other entities that match orders for futures contracts often desire to preserve the flexibility and precision available with a relatively small contract size. In contrast, delivery contract sizes are generally larger and constructed to appeal to large institutional or commercial traders. For example, a CBOT 10-year U.S. Treasury futures contract traded at an exchange may be based upon the delivery of a $100,000 face value unit of U.S. Treasury securities whose value may fluctuate somewhat above or below $100,000 in monetary value. At the same time, a “round lot” of Treasury securities as traded in commercial institutional Treasury markets is considered a $1 million face value unit.

Futures contracts have a limited duration. For example, E-mini S&P 500 futures contracts terminate on the 3^{rd} Friday of the contract months of March, June, September and December, at which date they are “cash-settled” at the Special Opening Quotation of the S&P 500 index. Certain trading strategies require the holding of futures contracts. For example, “portable alpha” asset management strategies require that the asset manager consistently hold a long position in a futures contract, such as the S&P 500, to replicate the “core” or “benchmark” returns associated with the index. When a futures contract expires, the ability to roll forward the position at a favorable price may impact the success of the strategy. Traders may be subjected to unexpected price changes.

Therefore, there is a need in the art for improved systems and methods for processing futures contracts as settlement dates approach.

### SUMMARY OF THE INVENTION

Embodiments of the present invention overcome problems and limitations of the prior art by providing systems and methods for requiring minimum position limits or thresholds as a settlement date approaches. Futures contracts may be listed with quantities that are multiples of a trading unit. A minimum position limit or a threshold that exceeds the trading unit may be required as the settlement date approaches. The limit or threshold may be enforced by imposing a fee for non-compliance, forcing cash settlement or requiring a mandatory roll forward of at least some of the positions. The roll forward may include a spread product that includes a first derivative financial instrument having a first settlement date and a second derivative financial instrument having a second settlement date that is different from the first settlement date. The price of the spread product is based on daily settlement values associated with the first and second derivative financial instruments.

In other embodiments, embodiments of the present invention can be partially or wholly implemented on a computer-readable medium, for example, by storing computer-executable instructions or modules, or by utilizing computer-readable data structures.

Of course, the methods and systems of the above-referenced embodiments may also include other additional elements, steps, computer-executable instructions, or computer-readable data structures. In this regard, other embodiments are disclosed and claimed herein as well.

The details of these and other embodiments of the present invention are set forth in the accompanying drawings and the description below. Other features and advantages of the invention will be apparent from the description and drawings, and from the claims.

### BRIEF DESCRIPTION OF THE DRAWINGS

The present invention may take physical form in certain parts and steps, embodiments of which will be described in detail in the following description and illustrated in the accompanying drawings that form a part hereof, wherein:

FIG. 1 shows a computer network system that may be used to implement aspects of the present invention;

FIG. 2 includes a chart that shows a requirement minimum position threshold over time for a derivative financial instrument, in accordance with an embodiment of the invention;

FIG. 3 illustrates a process that may be used by an exchange or other entity in connection with the trading of derivative financial instruments that have different trading units and position thresholds in accordance with an embodiment of the invention;

FIG. 4 illustrates an alternative process that may be used by an exchange or other entity in connection with the trading of derivative financial instruments that have minimum position limits;

FIG. 5 symbolically shows a strategy that consists of three different positions; and

FIG. 6 illustrates a process that may be used by an exchange or other entity to implement a roll that occurs at settlement, in accordance with an embodiment of the invention.

### DETAILED DESCRIPTION OF THE INVENTION

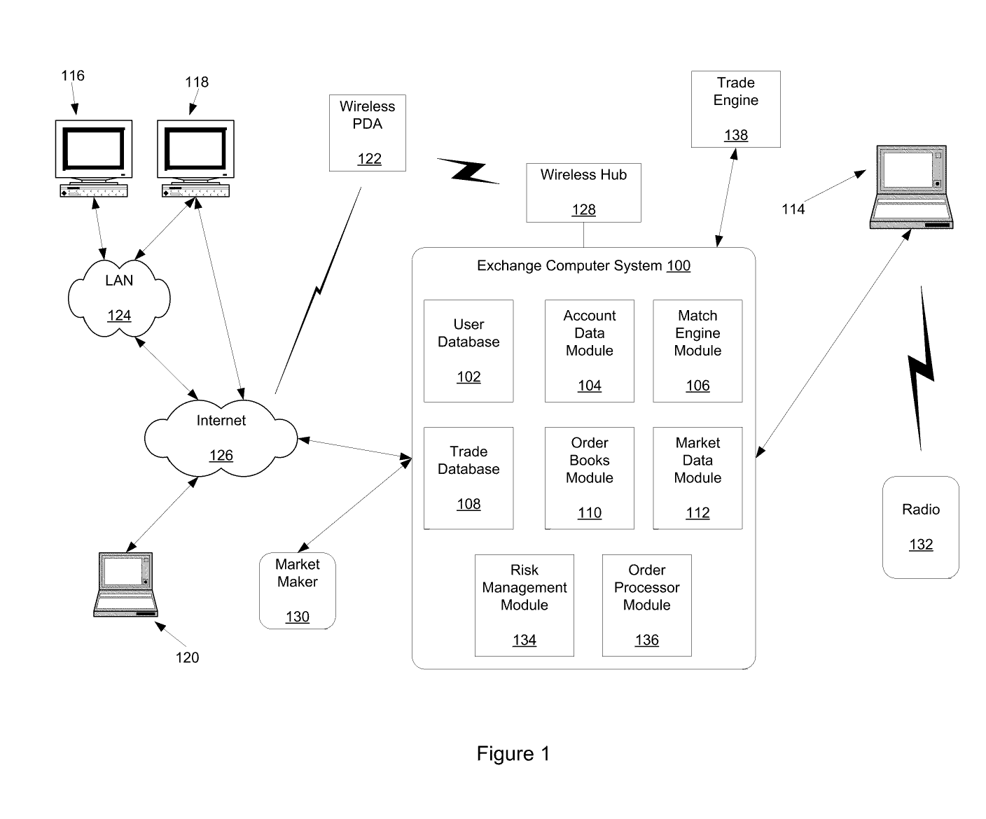

Aspects of the present invention may be implemented with computer devices and computer networks that allow users to exchange trading information. An exemplary trading network environment for implementing trading systems and methods is shown in FIG. 1. An exchange computer system 100 receives orders and transmits market data related to orders and trades to users. Exchange computer system 100 may be implemented with one or more mainframe, desktop or other computers. A user database 102 includes information identifying traders and other users of exchange computer system 100. Data may include user names and passwords potentially with other information to identify users uniquely or collectively. An account data module 104 may process account information that may be used during trades. A match engine module 106 is included to match bid and offer prices. Match engine module 106 may be implemented with software that executes one or more algorithms for matching bids and offers. A trade database 108 may be included to store information identifying trades and descriptions of trades. In particular, a trade database may store information identifying the time that a trade took place and the contract price. An order book module 110 may be included to compute or otherwise determine current bid and offer prices. A market data module 112 may be included to collect market data and prepare the data for transmission to users. A risk management module 134 may be included to compute and determine a user's risk utilization in relation to the user's defined risk thresholds. An order processor module 136 may be included to decompose variable defined derivative product and aggregate order types for processing by order book module 110 and match engine module 106.

The trading network environment shown in FIG. 1 includes computer devices 114, 116, 118, 120 and 122. Each computer device includes a central processor that controls the overall operation of the computer and a system bus that connects the central processor to one or more conventional components, such as a network card or modem. Each computer device may also include a variety of interface units and drives for reading and writing data or files. Depending on the type of computer device, a user can interact with the computer with a keyboard, pointing device, microphone, pen device or other input device.

Computer device 114 is shown directly connected to exchange computer system 100. Exchange computer system 100 and computer device 114 may be connected via a T1 line, a common local area network (LAN) or other mechanism for connecting computer devices. Computer device 114 is shown connected to a radio 132. The user of radio 132 may be a trader or exchange employee. The radio user may transmit orders or other information to a user of computer device 114. The user of computer device 114 may then transmit the trade or other information to exchange computer system 100.

Computer devices 116 and 118 are coupled to a LAN 124. LAN 124 may have one or more of the well-known LAN topologies and may use a variety of different protocols, such as Ethernet. Computers 116 and 118 may communicate with each other and other computers and devices connected to LAN 124. Computers and other devices may be connected to LAN 124 via twisted pair wires, coaxial cable, fiber optics or other media. Alternatively, a wireless personal digital assistant device (PDA) 122 may communicate with LAN 124 or the Internet 126 via radio waves. PDA 122 may also communicate with exchange computer system 100 via a conventional wireless hub 128. As used herein, a PDA includes mobile telephones and other wireless devices that communicate with a network via radio waves.

FIG. 1 also shows LAN 124 connected to the Internet 126. LAN 124 may include a router to connect LAN 124 to the Internet 126. Computer device 120 is shown connected directly to the Internet 126. The connection may be via a modem, DSL line, satellite dish or any other device for connecting a computer device to the Internet.

One or more market makers 130 may maintain a market by providing bid and offer prices for a derivative or security to exchange computer system 100. Exchange computer system 100 may also exchange information with other trade engines, such as trade engine 138. One skilled in the art will appreciate that numerous additional computers and systems may be coupled to exchange computer system 100. Such computers and systems may include clearing, regulatory and fee systems. Coupling can be direct as described or any other method described herein.

The operations of computer devices and systems shown in FIG. 1 may be controlled by computer-executable instructions stored on a computer-readable medium. Various computer-readable media that are tangible and non-transitory may be used. In one example, computer device 116 may include computer-executable instructions for receiving order information from a user and transmitting that order information to exchange computer system 100. In another example, computer device 118 may include computer-executable instructions for receiving market data from exchange computer system 100 and displaying that information to a user.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may be connected by numerous alternative topologies.

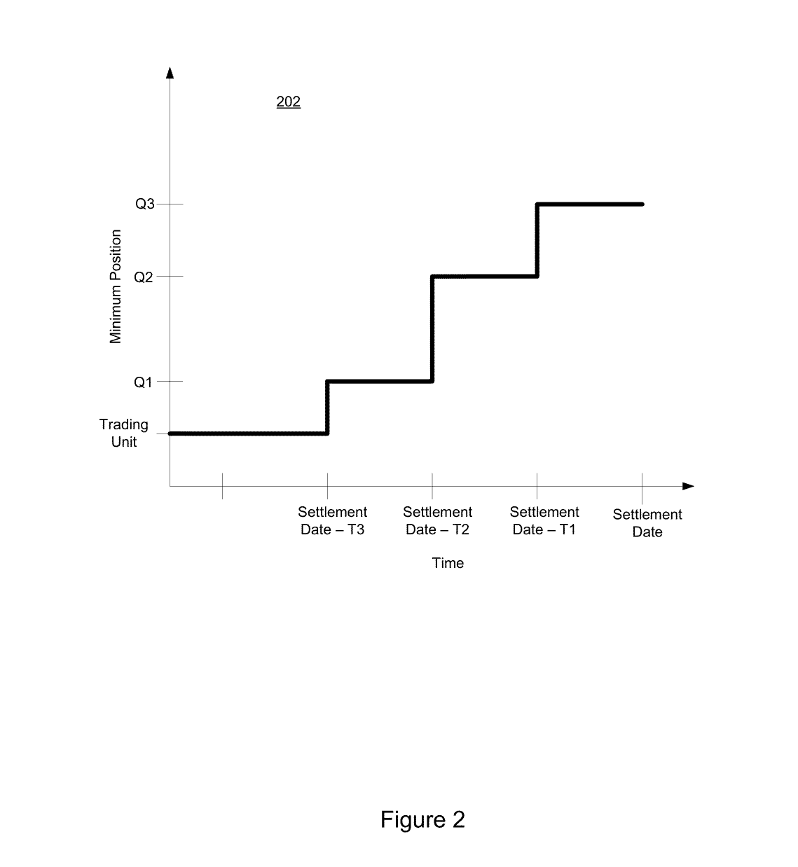

FIG. 2 includes a chart 202 that shows a requirement minimum position threshold over time for a derivative financial instrument, in accordance with an embodiment of the invention. Initially the minimum position quantity corresponds to a trading unit for the derivative financial instrument. As an example, the trading unit may be $100,000 for a futures contract based on U.S. Treasury securities. Over time, the minimum position may be increased so that at a settlement date the minimum corresponds to a value typically used by large institutional investors. In the example above, at the settlement date a minimum position of $1 million would be required.

Chart 202 shows that the minimum position requirements may be increased in multiple steps. In some embodiments the minimum position quality may be increased from the trading unit quantity to the final quantity in one, two, three, four or more steps. The step sizes may be uniform or non-uniform. As will be described in detail below, an exchange or other entity may use various procedures to enforce minimum position limits.

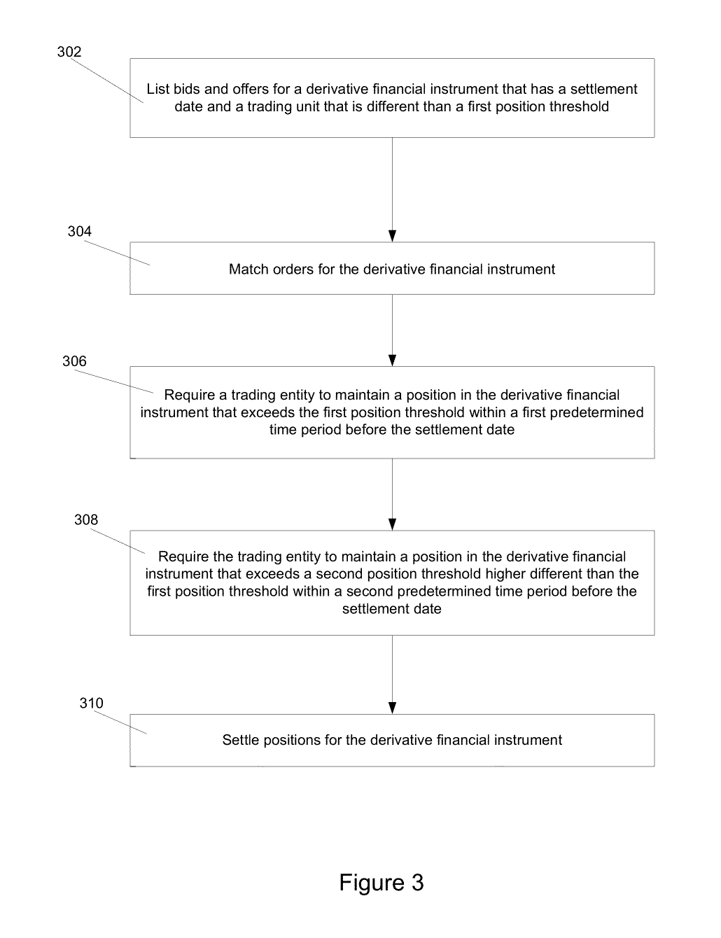

FIG. 3 illustrates a process that may be used by an exchange or other entity in connection with the trading of derivative financial instruments that have different trading units and position thresholds in accordance with an embodiment of the invention. First in step 302 bids and offers are listed for a derivative financial instrument that has a settlement date and a trading unit that is different than a first position threshold. The listing may show the depth of an order book. In some embodiments the listing also includes one or more position thresholds. The position thresholds may be displayed on a user interface screen that allows traders to submit bids and offers. In step 304 orders for the derivative financial instruments are matched. Step 304 may be performed at a match engine module, such as match engine module 106, at another computer device that includes a processor or at some other device. In step 306 a trading entity is required to maintain a position in the derivative financial instrument that exceeds the first position threshold within a first predetermined time period before the settlement date. The first position threshold may be a minimum and the predetermined time period before the settlement date may be a month or two before the settlement date. Of course, the predetermined time period before the settlement date may be other time periods before the settlement date. Next, an incremental position threshold may be implemented in step 308 in which the trading entity is required to maintain a position in the derivative financial instrument that exceeds a second position threshold higher different than the first position threshold within a second predetermined time period before the settlement date. The process shown in FIG. 3 includes two thresholds. In alternative embodiments one, three, four, five or more thresholds are used.

Finally, in step 310 positions for the derivative financial instrument are settled.

Settlement may be by physical delivery. Alternatively, settlement may be a cash settlement and may be performed by a clearinghouse computer device, another device that includes a processor or some other device.

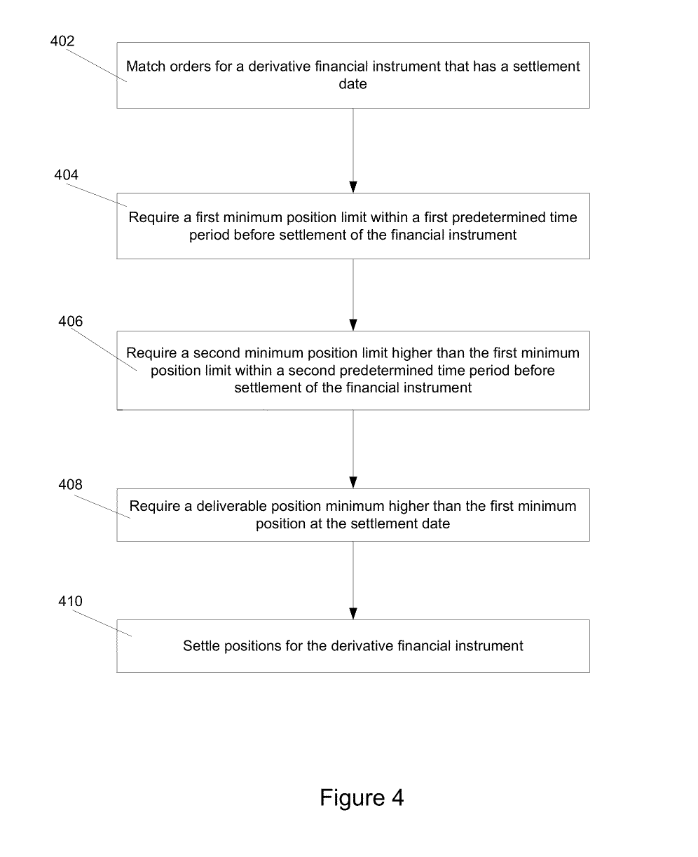

FIG. 4 illustrates an alternative process that may be used by an exchange or other entity in connection with the trading of derivative financial instruments that have minimum position limits. First, in step 402 orders for a derivative financial instrument that has a settlement date are matched. The derivative financial instrument may be a futures contract, such as a U.S. Treasury futures contract. Step 402 may be performed at a match engine module, such as match engine module 106, at another computer device that includes a processor or at some other device. A first minimum position limit within a first predetermined time period before settlement of the financial instrument is required in step 404 and a second minimum position limit higher than the first minimum position limit within a second predetermined time period before settlement of the financial instrument is required in step 406. When three minimum position levels are required, in step 408 a deliverable position minimum higher than the second minimum position is required at the settlement date. The deliverable position minimum may alternatively be required shortly before the settlement date, such as a day, two days or a week before the settlement date. The process shown in FIG. 4 includes three thresholds. In alternative embodiments one, two, four, five or more thresholds are used. In step 410 positions for the derivative financial instrument are settled. Settlement may be by physical delivery. Alternatively, settlement may be a cash settlement and may be performed by a clearinghouse computer device, another device that includes a processor or some other device.

Position thresholds and minimum position requirements may be enforced by imposing a fee for noncompliance or by imposing other disciplinary action as appropriate to compel compliance with the policy. Alternatively, for settlement purposes positions may be matched to the extent possible and cash settled otherwise. For example, if deliverable position minimum consists of a multiple of ten times a trading unit and a first trader is long ten (10) trading units and a second trader is short ten (10) trading units, those ten contracts could be matched for purposes of delivery. When matching for delivering, priority may be assigned randomly or assigned based on the age or seasoning of the positions. Priority may also be assigned to positions that have remained unmatched after an attempt to match. If traders hold “odd” or non-deliverable units less than the 10 trading units and the positions cannot be matched in integral multiples of the delivery unit, other provisions may be applied. For example, deliverable units may be matched to the extent possible and any remaining non-deliverable odd lots may be cash settled.

Contracts may also be structured so that positions that are not matched at settlement are subject to a roll forward. Rolling forward may be accomplished by liquidating a current position in a derivative financial instrument having a first settlement date and acquiring another position in derivative financial instrument having a second later settlement date. For example, a roll forward may include selling out of long, or buying back short, positions in the nearby month and simultaneously buying (going long) or selling (going short) positions in a deferred contract month.

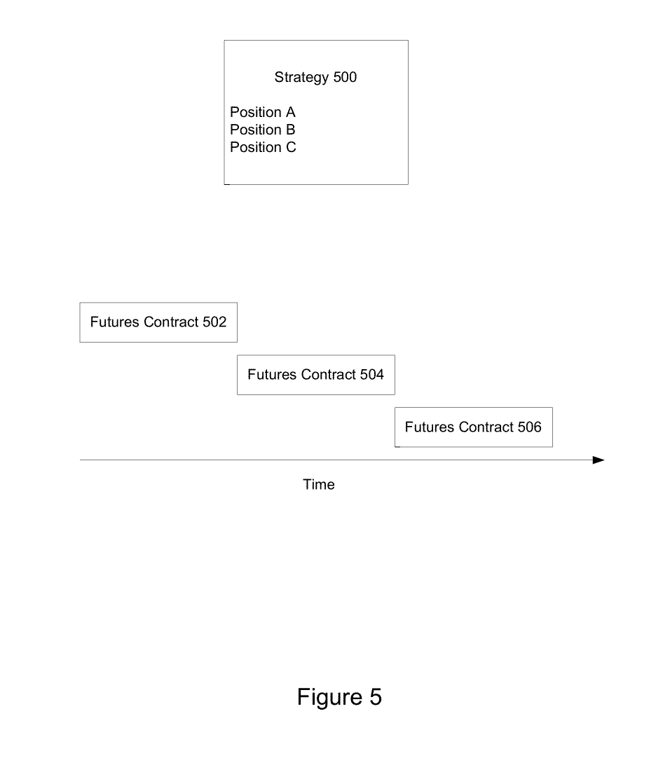

Roll forwards may also be used when traders are trying to implement various strategies, such as “portable alpha” asset management strategies. FIG. 5 symbolically shows a strategy 500 that consists of three different positions. One or more of the positions may include a futures contract. In order to implement the strategy a trader or another entity must simultaneously maintain all three positions. Futures contracts inherently have limited durations which result in the requirement that the trader or other entity periodically liquidate one position and acquire another position. FIG. 5, for example, shows a sequence of futures contracts 502, 504 and 506 that have different settlement dates. The sequence of futures contracts may be used to maintain one of the positions shown in strategy 500.

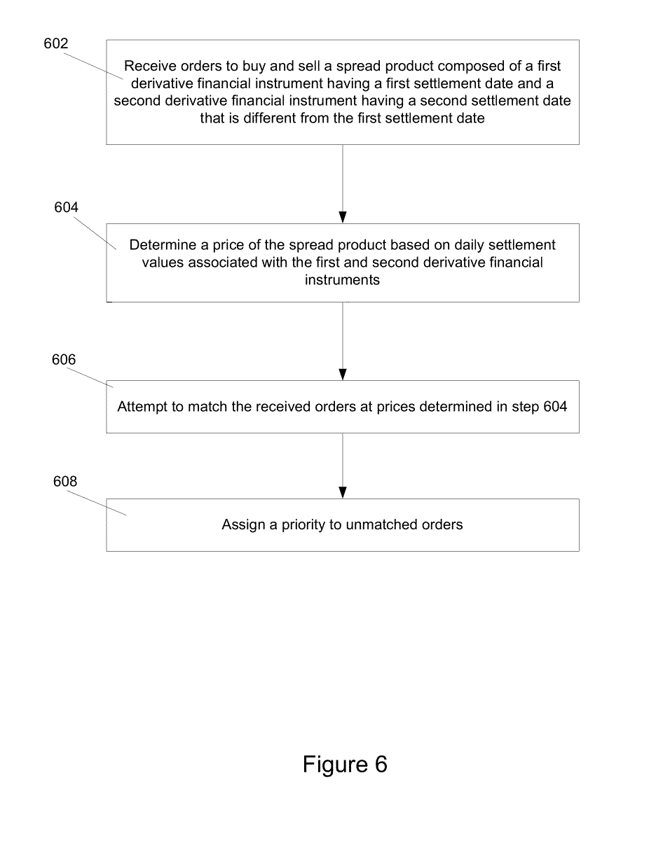

FIG. 6 illustrates a process that may be used by an exchange or other entity to implement a roll that occurs prior to or at settlement. First, in step 602 orders to buy and sell a spread product are received. The spread product may be composed of a first derivative financial instrument having a first settlement date and a second derivative financial instrument having a second settlement date that is different from the first settlement date. A trader or other entity may transmit an order to “sell the roll” (sell a nearby futures contract and buy a deferred futures contract) or “buy the roll” (buy a nearby futures contract and sell a deferred futures contract) at a singular price or value. Next, in step 604 a price of the spread product is determined based on daily settlement prices associated with the first and second derivative financial instruments. The settlement values may be established by an exchange-administered daily settlement process. For example, futures contracts may be marked-to-market (MTM) at the daily settlement price. These daily settlement prices are established by the exchange to represent a representative price as prevailed in the marketplace near the close of trading for the day. Daily settlement prices are generally regarded as fair and reasonable.

In step 606 an attempt is made to match the received orders at the settlement prices determined in step 604. Step 606 may be performed at a match engine module, another computer device that includes a processor or at some other device. Finally, a priority may be assigned to any unmatched orders in step 608. Priority may be assigned randomly or assigned based on the age or seasoning of the orders or some other established priority criteria.

A roll may occur on the day that a derivative financial instrument expires or at other times, such as one or two days before the expiration, a month before expiration or any other time before expiration. When a trader enters an order, the trader may also indicate a time relative to the expiration date that the trader desires the roll to occur.

The process shown in FIG. 6 may be used to enforce the position thresholds and minimum position requirements described above. In particular, in some embodiments when a threshold or minimum position requirement is not met a roll may be implemented.

The present invention has been described herein with reference to specific exemplary embodiments thereof. It will be apparent to those skilled in the art, that a person understanding this invention may conceive of changes or other embodiments or variations, which utilize the principles of this invention without departing from the broader spirit and scope of the invention as set forth in the appended claims. All are considered within the sphere, spirit, and scope of the invention.

What is claimed is:

1. A method comprising:
(a) receiving orders to buy and sell a spread product composed of a first derivative financial instrument having a first settlement date and a second derivative financial instrument having a second settlement date that is different from the first settlement date;
(b) determining a price of the spread product based on daily settlement values associated with the first and second derivative financial instruments; and
(c) at a processor, attempting to match orders received in (a) at prices determined in (b).

2. The method of claim 1, wherein the first and second derivative financial instruments comprise futures contracts.

3. The method of claim 1, wherein the orders received in (a) are received at an exchange.

4. The method of claim 1, wherein the daily settlement values in (b) are determined by an exchange.

5. The method of claim 1, wherein (c) comprises giving priority to the oldest orders.

6. The method of claim 1, wherein (c) comprises assigning a random priority to orders received in (a).

7. The method of claim 1, further comprising:
(d) assigning a priority to unmatched orders.

8. The method of claim 1, wherein at least some of the orders received in (a) are to buy the first derivative financial instrument and to sell the second derivative financial instrument.

9. The method of claim 8, wherein at least some of the orders received in (a) are to sell the first derivative financial instrument and to buy the second derivative financial instrument.

10. The method of claim 1, wherein (c) is performed within a predetermined time period before the first settlement date.

11. A computer system comprising:
a match engine configured to match orders;
a non-transitory computer-readable medium containing computer-executable instructions that when executed cause the match engine to perform the steps comprising:
(a) receiving orders to buy and sell a spread product composed of a first derivative financial instrument having a first settlement date and a second derivative financial instrument having a second settlement date that is different from the first settlement date;
(b) determining a price of the spread product based on daily settlement values associated with the first and second derivative financial instruments; and
(c) attempting to match orders received in (a) at prices determined in (b).

12. The computer system of claim 11, wherein the first and second derivative financial instruments comprise futures contracts.

13. The computer system of claim 11, wherein (c) comprises giving priority to the oldest orders.

14. The computer system of claim 11, wherein (c) comprises assigning a random priority to orders received in (a).

15. The computer system of claim 11, wherein at least some of the orders received in (a) are to buy the first derivative financial instrument and to sell the second derivative financial instrument.

16. The computer system of claim 11, further comprising computer-executable instructions for:
(d) assigning a priority to unmatched orders.

17. A non-transitory computer-readable medium containing computer-executable instructions that when executed cause a processor to perform the steps comprising:
(a) receiving orders to buy and sell a spread product composed of a first derivative financial instrument having a first settlement date and a second derivative financial instrument having a second settlement date that is different from the first settlement date;
(b) determining a price of the spread product based on daily settlement values associated with the first and second derivative financial instruments; and
(c) attempting to match orders received in (a) at prices determined in (b).

18. The computer-readable medium of claim 17, wherein the first and second derivative financial instruments comprise futures contracts.

19. The computer-readable medium of claim 17, further comprising computer-executable instructions for:
(d) assigning a priority to unmatched orders

20. The computer-readable medium of claim 17, wherein (c) comprises giving priority to the oldest orders.
